(19) United States
(12) Patent Application Publication
(10) Pub. No.: US 2012/0154256 A1
(43) Pub. Date: Jun. 21, 2012

(54) Visual Display System

(76) Inventors: Brett Loring Grover, Hyde Park, OH (US); William Henry Othick, Centerville, OH (US); Brent Jeremy Duersch, Cincinnati, OH (US)

(21) Appl. No.: 13/196,932

(22) Filed: Aug. 3, 2011

Related U.S. Application Data
(60) Provisional application No. 61/371,384, filed on Aug. 6, 2010.

(51) Int. Cl. G09G 5/00

(52) U.S. Cl. 345/2.1; 345/3.1; 345/1.1

(57) ABSTRACT

A visual display system and method for displaying information are disclosed. The visual display system includes at least two visual displays, where each visual display is produced using more than one image displaying device, and where at least two of the visual displays are oriented so that they are directed towards each other. The system further includes a CPU, and the lower edge of each of visual displays is elevated at least about 48 inches from the floor. In one embodiment of the invention, the image displaying devices are selected from the group consisting of projectors operating in combination with a screen or wall, LCD screens, LED screens, plasma screens and CRT screens.

### CROSS REFERENCE TO RELATED APPLICATIONS

This application claims the benefit of U.S. Provisional Application No. 61/371,384, filed Aug. 6, 2010.

### FIELD OF THE INVENTION

The present invention relates to a system for displaying large amounts of visual information using multiple displays in multiple areas within a room.

### BACKGROUND OF THE INVENTION

It is generally known to produce a single visual image using multiple visual displays. The images from multiple projectors have been combined to produce a large, continuous image. Prior patents and other disclosures have disclosed methods for blending multiple images, with particular focus on the smooth transition of the image as it crossed between images from different projectors.

U.S. Pat. No. 7,367,681 discloses a method and device for combing images from at least two light projectors. The patent focuses on a method for obtaining predictable image characteristics in the transition zone between overlapping images.

U.S. Publication No. 2005/0052623 discloses a system for combing projected images on a curved wall or screen. The image data are processed by a curved surface calculation. The electronic devices are synchronized with the server electronic device so that the electronic devices cooperate to drive corresponding projectors for showing an output image.

U.S. Publication No. 2005/0125488 discloses a display system for a large, high-resolution display that is scalable. The scalable display is made up of a number of smaller displays. The resolution of the scalable display is the combined resolutions of the smaller displays according to the vertical and horizontal layout of the smaller displays. The system includes an intermediate computer that acts as a primary client to a network computer to request and receive video data at the resolution of the scalable display. The intermediate computer reconfigures video data from a format consistent with the large, scalable display coordinates to a format consistent with the coordinates of the individual smaller displays. The intermediate computer sends reconfigured video data to the smaller displays (through clients) according to which portion of the scalable display each of the smaller displays supports.

However, none of these disclosures address the issue of using large screens in a meeting/conference room environment, where the meeting participants typically face each other around a table. Inevitably, a large screen on one wall will force many of the meeting participants to turn and focus on the image, and not on the other attendees.

As such, there exists a need for a system that allows continued face-to-face discussions in a conference room-type setting while using a large visual display.

### SUMMARY OF THE INVENTION

According to one embodiment of the invention, there is provided a visual display system that allows meeting attendees to face each other in a typical conference room manner. Visual information will be displayed above the heads of the meeting attendees located opposite them at the table. This display system produces a comfortable meeting atmosphere where attendees can sit face-to-face, glancing up slightly to view a large amount of displayed information. The visual display system includes at least two visual displays, where each visual display is produced using more than one image displaying device, and where at least two of the visual displays are oriented so that they are directed towards each other. The system further includes a CPU, and the lower edge of each of visual displays is elevated at least about 48 inches from the floor. In one embodiment of the invention, the image displaying devices are selected from the group consisting of projectors operating in combination with a screen or wall, LCD screens, LED screens, plasma screens and CRT screens.

In another embodiment, the system also includes one or more separate image displaying devices for displaying individuals at a remote location. In addition, at least two different types of image displaying devices may be used. If a projector and screen are used as an image displaying device, the screen may be curved.

A method for displaying information in a room having walls and a floor is also disclosed. The method comprises displaying the same image on more than one location in the room using multiple visual displays, where each visual display is produced using at least two image displaying devices; orienting the multiple visual displays so that at least two of them are directed towards each other; and connecting the multiple visual displays to a CPU; where the CPU controls the image that is being displayed on the multiple visual displays. In another embodiment, a computer network is connected to the CPU. Further, a remotely located CPU is connected to the computer network, and the remotely located CPU receives the same visual display data as that being transmitted to the multiple visual displays.

### BRIEF DESCRIPTION OF THE DRAWINGS

While the specification concludes with the claims particularly pointing out and distinctly claiming the invention, it is believed that the present invention will be better understood from the following description taken in conjunction with the accompanying drawings in which:

FIG. 1 illustrates an exemplary block diagram representation of one embodiment of a visual display system in accordance with the present invention.

FIG. 2 illustrates an exemplary block diagram representation of a second embodiment of a visual display system in accordance with the present invention.

### DETAILED DESCRIPTION OF THE INVENTION

The system of the present invention is suitable for displaying large amounts of visual information simultaneously at multiple locations in a room. For purposes of illustrating the present invention in detail, but without intending to limit the scope of the invention, the invention will be described as a system for displaying visual information using multiple displays in multiple areas within a room.

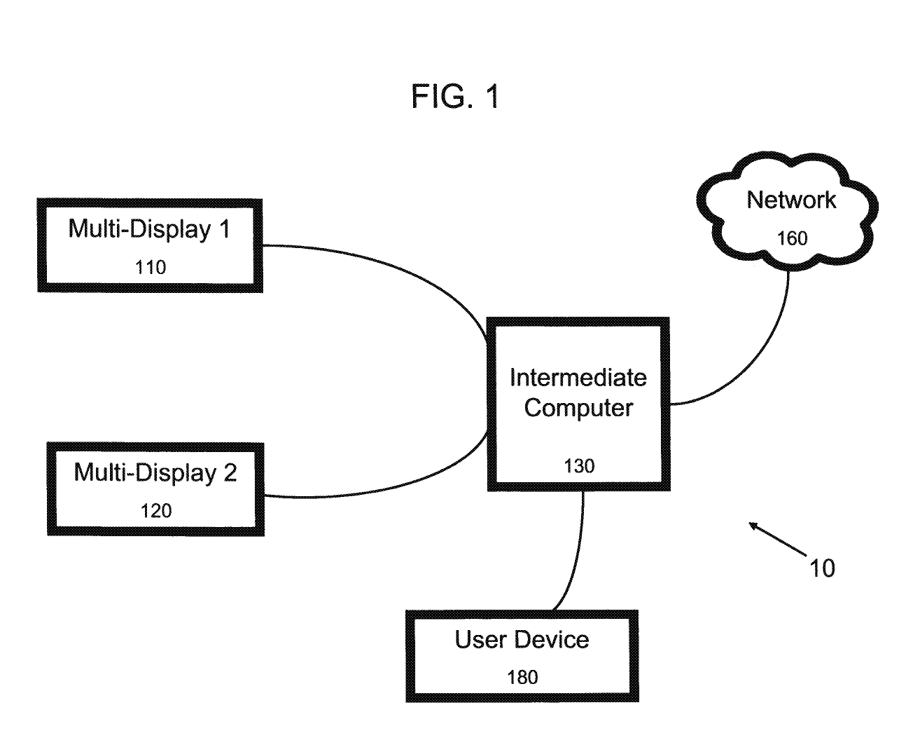

Referring to FIG. 1, a system 10 is represented comprising at least two Multi-Displays 110 and 120, which display the same visual image being provided by an Intermediate Computer 130. The Intermediate Computer 130 is connected to a User Device 180. The Intermediate Computer 130 is also connected to a Network 160 to allow communication with computers in other locations.

In one aspect of the invention, the Multi-Displays 110 and 120 may comprise multiple projectors operating in combination with a screen or wall, multiple LCD screens, multiple LED screens, multiple plasma screens and/or multiple CRT screens. As used herein, “Multi-Display” refers to multiple image generating devices that are located next to each other and can display a single unified image using all the image generating devices. In other words, a Multi-Display is arranged by combining several display apparatuses together. Each display apparatus selects a part of the image according to the corresponding arranged position and scales to a full-screen size of the display apparatus. All the combined display apparatuses therefore jointly display a whole image of the input signal. In one embodiment, the Multi-Displays 110 and 120 are each produced using multiple light projectors in combination with a screen mounted on a wall. The screens can be made from a variety of materials, including vinyl, cloth, and other fabrics mounted on a support structure. Rigid materials, such as acrylic or glass, may also be used as screen material. Preferably, three projectors are used to produce each Multi-Display 110 and 120. Alternatively, four projectors are used to produce each Multi-Display 110 and 120. In another embodiment, the Multi-Displays 110 and 120 are each produced using multiple LCD screens. Preferably, each Multi-Display (110, 120) is produced using three LCD screens placed side-by-side. Alternatively, each Multi-Display (110, 120) is produced using four LCD screens placed side-by-side.

In one embodiment, the multi-displays have an image resolution of at least 18 ppi (pixels per inch). Preferably, the multi-displays have an image resolution of at least 25 ppi. The overall height of a multi-display is preferably at least about 18 inches, more preferably at least about 24 inches, still more preferably at least about 36 inches. The overall width of a multi-display is preferably at least about 5 feet, more preferably at least about 6 feet, still more preferably at least about 8 feet. In one embodiment of the invention, at least two different types of image displaying devices are used to create multi-displays. In other words, one multi-display may be produced using LCD screens, while another multi-display is formed using LED screens.

The Multi-Displays 110 and 120 are connected to an Intermediate Computer 130 which may be implemented as a variety of general purpose computing devices such as a server computer, a workstation computer, a desktop computer, a laptop computer, or other form of personal computer (PC). The Multi-Displays 110 and 120 receive video data from the Intermediate Computer 130. In one embodiment, the Intermediate Computer 130 is connected to a User Device 180. The User Device 180 can be a personal computer, an interactive hand-held device (such as a remote, a touchscreen, a WiFi connected device or a mobile cellular device like a cell phone or Smartphone) or some other form of computer that is operatively coupled to the Intermediate Computer 130 at various times, either directly or through a network. The User Device 180 allows a user to control the images displayed on the Multi-Displays 110, 120. The visual information displayed on the Multi-Displays 110, 120 can originate from data stored on the User Device 180, the Intermediate Computer 130 and/or data from the Network 160.

The Intermediate Computer 130 is connected to a computer Network 160. The Network 160 is typically a remote IP (Internet Protocol) network connection. However, it can also include local connections depending on the particular system configuration. Thus, Network 160 may include, for example, any one or a combination of a modem, a cable modem, a LAN (local area network), a WAN (wide area network), an intranet, the Internet, or any other suitable communication link. The connection to the Network 160 allows data to be retrieved for use in the visual information that is displayed on the Multi-Displays 110, 120. The connection to the Network 160 also allows information to be sent from the Intermediate Computer 130 to the Network 160. This enables remote data storage, as well as viewing of the visual information by remote users. For example, the visual information and other data used in a meeting room can be transmitted via the Network 160 to a remote viewing location, where additional meeting participants can observe the data being displayed. Furthermore, the remote viewing location may be connected to the meeting room via a telephone connection or video conference display, so the additional meeting participants may communicate with the meeting room.

In an alternative embodiment, the visual information displayed on the Multi-Displays 110 and 120 may be controlled directly from the Intermediate Computer 130, without the use of the User Device 180.

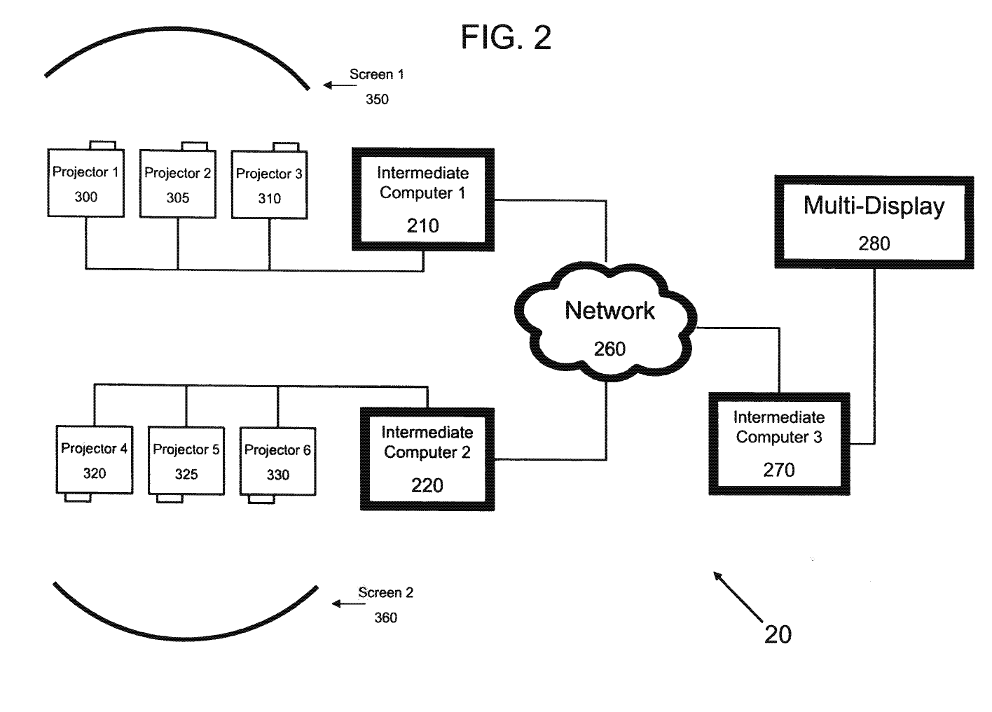

Now referring to FIG. 2, a system 20 is represented which comprises multiple Projectors 300, 305, 310, 320, 325 and 330 for projecting images on Screens 350 and 360. In this embodiment, the screens 350 and 360 are curved. However, flat screens could also be used.

The curvature of the screens may vary. Preferably, the screens 350 and 360 will have the same curvature, or will both be flat. In one embodiment, the radius of each screen will match the curved edge of a central table, such as a conference table, this table being located between the screens.

Projectors 300, 305, and 310 are connected to Intermediate Computer 1 (210) and Projectors 320, 325 and 330 are connected to Intermediate Computer 2 (220). Intermediate Computers 1 and 2 (210, 220) may be implemented as a variety of general purpose computing devices such as a server computer, a workstation computer, a desktop computer, a laptop computer, or other form of personal computer (PC). Projectors 300, 305, and 310 receive video data from Intermediate Computer 1 (210). Projectors 320, 325, and 330 receive video data from Intermediate Computer 2 (220). Intermediate Computers 1 and 2 (210, 220) are connected to a Network 260.

The Network 260 is typically a remote IP (Internet Protocol) network connection. However, it can also include local connections depending on the particular system configuration. Thus, Network 260 may include, for example, any one or a combination of a modem, a cable modem, a LAN (local area network), a WAN (wide area network), an intranet, the Internet, or any other suitable communication link The connection to the Network 260 allows data to be retrieved for use in the visual information that is displayed on the Projectors 300, 305, 310, 320, 325 and 330. The connection to the Network 260 also allows information to be sent from Intermediate Computer 3 (270) and/or Intermediate Computers 1 and 2 (210, 220) to the Network 260.

Intermediate Computer 3 (270) is connected to the Network 260 as well as Multi-Display 280. Intermediate Computer 3 (270) may be implemented as a variety of general purpose computing devices such as a server computer, a workstation computer, a desktop computer, a laptop computer, or other form of personal computer (PC). Multi-Display 280 receives video data from the Intermediate Computer 3 (270). Multi-Display 280 may comprise multiple projectors operating in combination with a screen or wall, multiple LCD screens, multiple LED screens, multiple plasma screens and/or multiple CRT screens.

In one embodiment, Intermediate Computer 3 (270) is located in a room with at least one multi-display. Preferably, the room has at least two multi-displays. In FIG. 2, Multi-Display 280 receives visual data from the Intermediate Computer 3 (270). The visual data, as well as other data, is also transmitted to the computer Network 260. In a remote location, Intermediate Computers 1 and 2 (210, 220) receive the video data from the Network 260. The visual data is displayed in the remote location via the multiple Projectors 300, 305, 310, 320, 325 and 330. Furthermore, the remote location may be connected to the meeting room via a telephone connection or video conference display, so the additional meeting participants may communicate with the meeting room. This embodiment provides a system wherein a user can display large amounts of visual information simultaneously in more than one location.

In an alternative embodiment, the Intermediate Computer 3 (270) is connected to a user device, such as a personal computer, an interactive hand-held device (such as a remote, a touchscreen, a WiFi connected device or a mobile cellular device like a cell phone or Smartphone) or some other form of computer that is operatively coupled to the Intermediate Computer 3 (270) at various times, either directly or through a network. In this embodiment, the user device allows a user to control the images displayed on the Multi-Display 280.

In another embodiment, the Network 260 is connected to other intermediate computers in one or more other remote locations. The remote locations may have one or more multi-displays. Each of the intermediate computers receives the video data from the Intermediate Computer 3 (270). The remote locations can communicate with all other locations via telephone or video conferencing. This results in a series of connected meeting rooms, all sharing the same large amounts of visual data, virtually simultaneously. Preferably, the remote locations have two or more multi-displays, arranged in a similar configuration to the primary conference room (e.g., the room having multiple Projectors 300, 305, 310, 320, 325 and 330).

Various “desktop sharing” software programs are available to enable the simultaneous display of visual information in more than one location. In a preferred embodiment, the “Webex” system, currently marketed by Cisco Systems, Inc. is used to enable the display of visual information. The Webex system provides a distributed collaborative computer system that supports application sharing among an arbitrary number of client computers. This is accomplished by providing a plurality of server computers interconnected via one or more high-speed links Client computers can connect to any available server computer and start or join a conference hosted on either the server computer to which the client computer is connected or any other server in the system. Further details of this system are disclosed in U.S. Pat. No. 7,203,755.

In one embodiment of the current invention, the “desktop sharing” software enables remote viewers of a presentation to view the information on a smaller screen than the one or more multi-displays used in the primary meeting room. In this embodiment, the smaller screen is not able to display the entire image seen on a multi-display. This is accomplished by having the remote user's smaller screen “track” the mouse of the presenter. In other words, when the presenter moves his on-screen arrow using a mouse, the image on the remote viewer's screen will move to continue to show the area of the multi-display where the on-screen arrow is. Preferably, the remote user will be able to control his view of the multi-display data when the presenter is not moving his mouse. This type of control system is available using Cisco Systems' “Webex” software.

### The Room Environment

The visual display system of the present invention is intended for use in a room having walls and a floor. Preferably, the room is arranged as a conference room, having a large table in the center of the room and chairs on multiple sides of the table. In one embodiment, the large table has a curved edge, resulting in a table that has a round or oval shape. Preferably, the shape of the table is oval. More preferably, a visual display is located on the wall behind each of the two longer sides of the oval and the visual display is curved, having the same radius as the curve of the oval table in front of it.

The room contains at least two visual displays, and each visual display, or “multi-display,” is produced using more than one image displaying device. A multi-display is arranged by combining several display apparatuses together. Each display apparatus selects a part of the image according to the corresponding arranged position and scales to a full-screen size of the display apparatus. All the combined display apparatuses therefore jointly display a whole image of the input signal.

In one embodiment, the room has two multi-displays. A multi-display is positioned on two opposing walls of the room, with the table located in the room between the multi-displays.

The multi-displays are oriented so that they are directed towards each other. In other words, the image from each multi-display is visible from the table. The multi-displays each have a lower edge. Preferably, the lower edge is elevated at least about 36 inches from the floor. More preferably, the lower edge of each multi-display is elevated at least about 48 inches from the floor. Still more preferably, the lower edge of each multi-display is elevated at least about 52 inches from the floor. The lower edge of each multi-display may be a different height from the floor. Preferably, the lower edge of each multi-display is the same height from the floor. The height of the multi-displays allows the meeting attendees to comfortably view the displayed images without being blocked by the bodies and heads of the attendees seated across from them at the table. Preferably, the multi-displays are located on the walls of the room and no portion of the display area of a multi-display is located on the ceiling of the room.

The multi-displays simultaneously show the same visual information. Therefore, meeting attendees can view the information located in front of them, without needing to turn to view additional information that may not be on the multi-display they are currently viewing.

The arrangement of the room and visual display system allows continued face-to-face discussions in a conference room-type setting while using a large visual display. Because there are at least two multi-displays, meeting attendees can face each other in a typical conference room manner Visual information will be displayed above the heads of the meeting attendees located opposite them at the table. This results in a comfortable meeting atmosphere where attendees can sit face-to-face, glancing up slightly to view displayed information. The large size of the multi-displays is also preferred, since it allows a large amount of data to be comfortably displayed at one time.

Various types of visual information may be displayed on the multi-displays, including documents, spreadsheets, charts, prerecorded videos and live video feeds from remote cameras. Many commercially available software programs can be used to display the desired information. Such programs are well-known to those skilled in the art. Also, other means for displaying visual information that are known in the art are contemplated for the present invention.

In another embodiment, the room contains one or more video conferencing monitors. “Video conferencing,” as used herein, means a set of interactive telecommunication technologies which allow two or more locations to interact via two-way video and audio transmissions simultaneously. These video conferencing monitors are preferably located in an area of the room that will not block the attendees' line of sight to the multi-displays. Preferably, the video conferencing monitors are located on sides of the room that do not have multi-displays. Therefore, in a typical four-walled room, two opposing walls could have multi-displays and the other two walls could have video conferencing monitors.

In another embodiment, the room is equipped with audio conferencing hardware, allowing individuals at another location to participate in the meeting.

Every numerical range given throughout this specification will include every narrower numerical range that falls within such broader numerical range, as if such narrower numerical range were all expressly written herein. Further, the dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed:

1. A visual display system for use in a room having walls and a floor comprising:
a. At least two visual displays, wherein each visual display is produced using more than one image displaying device, and wherein at least two of said visual displays are oriented so that they are directed towards each other; and
b. A CPU;
wherein, said visual displays each have a lower edge and said lower edge is elevated at least about 48 inches from the floor.

2. The system of claim 1, wherein the image displaying devices are selected from the group consisting of projectors operating in combination with a screen or wall, LCD screens, LED screens, plasma screens and CRT screens.

3. The system of claim 1, wherein the image displaying devices are LCD screens.

4. The system of claim 1, wherein the image displaying devices are projected images on a screen or wall.

5. The system of claim 1, wherein at least two different types of image displaying devices are used.

6. The system of claim 1, further comprising one or more separate image displaying devices for displaying individuals at a remote location.

7. The system of claim 1, wherein the lower edge of said visual displays is elevated at least about 52 inches from the floor.

8. The system of claim 1, wherein each said visual display is produced using at least three image displaying devices.

9. The system of claim 1, wherein each said visual display is produced using at least four image displaying devices.

10. The system of claim 1 wherein the visual displays are curved.

11. The system of claim 1, wherein said visual display system comprises at least four visual displays.

12. The system of claim 1 wherein the visual displays have a resolution of at least about 18 ppi.

13. The system of claim 12 wherein the visual displays have a resolution of at least about 25 ppi.

14. The system of claim 1 wherein said CPU is connected to a computer network.

15. A method for displaying information in a room having walls and a floor comprising:
a. Displaying the same image on more than one location in the room using multiple visual displays, wherein each visual display is produced using at least two image displaying devices;
b. Orienting the multiple visual displays so that at least two of them are directed towards each other; and
c. Connecting the multiple visual displays to a CPU; wherein said CPU controls the image that is being displayed on the multiple visual displays.

16. The method of claim 15, further comprising connecting a computer network to the CPU.

17. The method of claim 16, further comprising connecting a remotely located CPU to the computer network, wherein the remotely located CPU receives the same visual display data as that being transmitted to said multiple visual displays.

18. The method of claim 17, further comprising connecting at least one visual display to said remotely located CPU, wherein each visual display is produced using at least two image displaying devices.

19. The method of claim 15, wherein said multiple visual displays each have a lower edge and said lower edge is elevated at least about 48 inches from the floor.

20. The method of claim 15, wherein said multiple visual displays each have a lower edge and said lower edge is elevated at least about 52 inches from the floor.
